(19) United States
(12) Patent Application Publication
(10) Pub. No.: US 2012/0026923 A1
(43) Pub. Date: Feb. 2, 2012

(54) CONNECTION OF A COMMUNICATIONS UNIT TO THE SOFTPHONE OF A PC

(75) Inventors: Michael W. Ferguson, Natick, MA (US); Fredrik Lindgren, Vellinge (SE)

(73) Assignee: GN Netcom A/S, Ballerup (DK)

(21) Appl. No.: 13/017,365

(22) Filed: Jan. 31, 2011

Related U.S. Application Data
(63) Continuation of application No. 10/578,733, filed on Jan. 8, 2007, now abandoned.

(30) Foreign Application Priority Data
Nov. 10, 2003 (DK) PA 2003 01664

(51) Int. Cl. H04L 12/66; H04W 12/00

(52) U.S. Cl. 370/310; 370/352

(57) ABSTRACT

A PC containing a softphone is connected to a headset (14) by means of a control unit (9) which is connected to a USB gate (6) in the PC. The PC has a security function, which means that the PC can be accessed only by users who e.g. know an access code. The control unit (9), comprising inter alia a sound card, is equipped such that also commands may be given to the softphone (15), even if for security reasons the PC is blocked e.g. by a security code, it being possible to transfer a limited number of commands via the USB gate (6) from the control unit (9). The invention ensures that, irrespective of the state of the PC, the softphone can always be used, as the control unit (9) always gives access to it, which may be important, e.g. in connection with an emergency call.

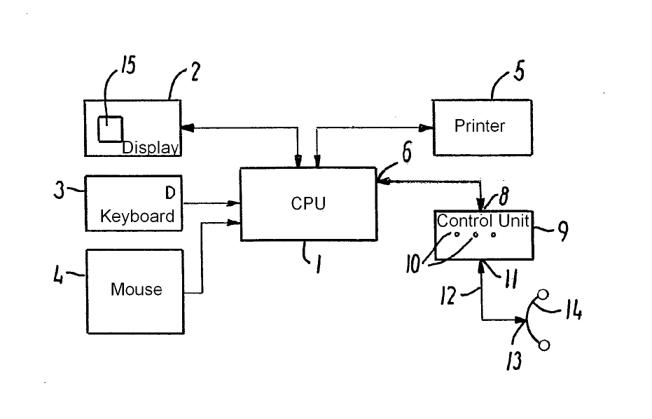

The invention relates to switching of a communications unit to the soft-phone of a PC via an electrical connection.

Such a switching is known from the published US Patent Application No. 2003/0096589 A1.

This known system uses two channels for communication, viz. partly a WAN (Wide Area Network) connection for normal calls and partly a mobile network for emergency calls to e.g. 911 in the USA or 112 in Denmark. The purpose is to make it possible for an emergency call to be localized by the receiver.

The document does not disclose or suggest whether it is possible to use the softphone if e.g. the PC associated with the softphone is blocked by an access code.

Accordingly, an object of the invention is to provide the option of using a softphone also even if the associated PC is blocked by a security setting.

The object of the invention is achieved by a switching of the type defined in the introductory portion of claim 1, which is characterized in that a control unit is coupled between the communications unit and the softphone, said control unit being adapted to transfer commands to the softphone, both when the PC is coupled in normal position and when the PC is coupled in security position.

The softphone may hereby be used also in those cases where the other communication paths of the PC are blocked.

An easy installation of the control unit may be provided if, as stated in claim 2, the control unit is connected to the softphone via a USB gate, while the communications unit is connected by a wire to the control unit.

If a user-friendly coupling is desired where the control unit “physically” follows the communications unit, i.e. is kept e.g. in a pocket, it is an advantage if, as stated in claim 3, the control unit is connected wirelessly, e.g. by means of a short range Bluetooth connection, to the softphone and the communications unit.

For a suitable number of various commands to be applied from the control unit to the softphone, it is expedient if, as stated in claim 4, the control unit has a plurality of setting buttons, e.g. three. If these buttons are arranged such that one or two depressions result in the application of a command, nine different commands may be given.

To maintain the security of the PC when it is blocked, e.g. by an access code, it is expedient if, as stated in claim 5, the PC, when blocked for use by the security setting, is open for the reception of a limited number of commands from the control unit to the softphone.

This advantage is enhanced additionally if, as stated in claim 6, the control unit comprises a sound card, since the access to the PC itself, including the use of its sound card when it is otherwise blocked, is limited to the greatest extent possible.

The user friendliness of the switching is increased if, as stated in claim 7, the communications unit is formed by a passive headset consisting of a microphone and a speaker.

To increase the flexibility of the switching according to the invention additionally, it is an advantage if, as stated in claim 8, the communications unit is formed by an active headset with its own power supply and control buttons.

Finally, it is an advantage if, as stated in claim 9, the headset is powered from the USB gate via the control unit for the charging of the headset.

The invention will now be explained more fully with reference to the single figure of the drawing.

The figure schematically shows a conventional PC structure containing the usual components, such as a CPU 1, a display 2, a keyboard 3, a mouse 4, and a printer 5.

Further, the PC may be connected to a softphone which is denoted 15 in the figure. In practice, this softphone 15 is a graphic telephone with graphic keys and function buttons, as is known from a stationary telephone or a mobile telephone. The graphic telephone is displayed on the display 2, but is shown here as an independent unit 15 for clarity.

The PC 1 has several connection options, one of which is denoted 6, which is a USB gate connected by a wire to an input 8 on a control unit 9 shown here with three buttons 10.

The control unit has a gate 11 which is coupled via a wire 12 to an input 13 on a communications unit, which may appropriately be a headset 14.

This headset may be of the passive type and merely consist of a microphone and a speaker. It may also be of the active type with is own power supply, amplifier and setting options.

It should moreover be noted that nothing prevents the control unit 9 from being coupled to the communications unit and the PC via wireless connections, such as the short range connection of the Bluetooth type or the so-called DECT standard.

The mode of operation of the setup will now be explained in greater detail.

When the PC is in its normal position, i.e. without any access code limitation, calls to and from the softphone are made via the headset 14.

Settings of the headset volume, attenuation, redialing, etc. may be controlled directly from the keyboard of the PC, or, if the headset is of the active type with independent setting options, may be set from this.

In those cases where the PC is on, but blocked, e.g. by an access code, it is nevertheless possible to transfer calls to or from the softphone in the PC, as the control unit 9 is adapted to be connected to the softphone and to transfer, only via the control buttons 10, a limited number of commands to the softphone, which may e.g. be the placing of emergency calls, answering of telephone calls and similar standard telephone functions. These limited commands may be provided through a driver or software application via the USB gate, which thus bypasses the access code of the PC, but do not allow the PC to be operated via the keyboard thereof.

All things considered, a very flexible access to a softphone is provided, no matter whether the PC is connected normally or it is blocked by a security code.

1. Switching of a communications unit to the softphone of a PC via an electrical connection, characterized in that a control unit is coupled between the communications unit and the softphone, said control unit being adapted to transfer commands to the softphone, both when the PC is coupled in normal position and when the PC is coupled in security position.

2. Switching according to claim 1, characterized in that the control unit is connected to the softphone via a USB gate, while the communications unit is connected by a wire to the control unit.

3. Switching according to claim 1, characterized in that the control unit is connected wirelessly, e.g. by a short range Bluetooth connection, to the softphone and the communications unit.

4. Switching according to claim 1, characterized in that the control unit (9) has a plurality of setting buttons (10), e.g. three.

5. Switching according to claim 1, characterized in that the PC, when blocked for use by the security setting, is open for the reception of a limited number of commands from the control unit to the softphone.

6. Switching according to claim 1, characterized in that the control unit comprises a sound card.

7. Switching according to claim 1, characterized in that the communications unit is formed by a passive headset consisting of a microphone and a speaker.

8. Switching according to claim 1, characterized in that the communications unit is formed by an active headset with its own power supply and control buttons.

9. Switching according to claim 8, characterized in that the headset is powered from the USB gate via the control unit for the charging of the headset.
